(19) United States
(12) Patent Application Publication
(10) Pub. No.: US 2018/0032953 A1
(43) Pub. Date: Feb. 1, 2018

(54) AUTOMATED RESUPPLY BASED ON SENSOR DATA

(71) Applicants: Michael MAYER, Seattle, WA (US); Liana HERRERA, Seattle, WA (US)

(72) Inventors: Michael MAYER, Seattle, WA (US); Liana HERRERA, Seattle, WA (US)

(21) Appl. No.: 15/655,342

(22) Filed: Jul. 20, 2017

Related U.S. Application Data
(60) Provisional application No. 62/368,857, filed on Jul. 29, 2016.

(51) Int. Cl. G06Q 10/08; G06Q 30/06; G06Q 10/06

(52) U.S. Cl. CPC G06Q 10/0875; G06Q 10/06315; G06Q 30/0635

(57) ABSTRACT

System for resupplying a consumable good based on sensors placed to measure the level or flow of a good, and using the data produced in predictive systems to determine the likelihood of running out of a good before resupply is likely to arrive, and triggering an order which arrives before supply is exhausted.

### CROSS-REFERENCE TO RELATED APPLICATIONS

This application claims the benefit of U.S. Provisional Application No. 62/368,857, filed Jul. 29, 2016.

### BACKGROUND OF THE INVENTION

This application relates to methods and systems for facilitating resupply orders for consumable goods, particularly the capturing of levels of consumable commodities and the processing of such data.

There exist several automated systems for resupplying consumable goods. The most basic of these systems is a subscription service where the goods are delivered on a specific schedule. Such a system is deficient in cases where consumption rates are not regular and equal to the frequency and amount of the resupply. As a result the goods are often either chronically oversupplied or chronically undersupplied.

Other systems track sensor data and resupply when levels of a good reach a certain “predetermined” level. Such systems are deficient in cases where patterns of use are not uniform. For instance, a user could be a heavy consumer of a good on weekends and not on weekdays, and the user could be just above the “predetermined level” on a day leading up to the weekend, in this case the system would fail to resupply the user adequately for the weekend due to the non-uniform pattern. Another deficiency exists when a user is either an unusually heavy or light consumer of the goods. In these cases the heavy consumer would be chronically underserved by the “predetermined” level for triggering resupply and the light consumer would be chronically oversupplied by the “predetermined” level for triggering resupply,

Other existing systems use “smart appliances” to measure the use of consumable goods. Such systems are deficient because the user may consume the consumable goods outside of the appliance, for instance a “smart toaster” would not be able to properly supply a user with bread because the user may eat both toasted and untoasted bread. Another deficiency of such systems is that the consumer may have a preferred brand of appliance, whether because the appliance has special proprietary technology or because of sentimental reasons, and would not like to use a different brand's “smart” version.

### BRIEF DESCRIPTION OF THE DRAWINGS

FIG. 1 illustrates a flow chart demonstrating overall functioning of system

FIG. 2 illustrates a flow chart demonstrating specific generation of likelihood-of-running-out table

### DETAILED DESCRIPTION OF THE INVENTION

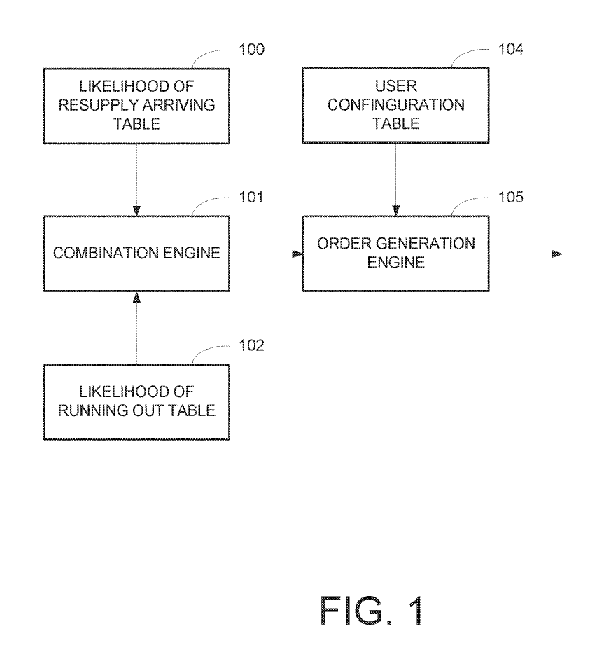

It is desirable for a system to more accurately determine the proper resupply of consumable goods of a user (e.g., consumer). FIG. 1 describes a combination of two aspects of determining when a resupply of a consumable is appropriate based upon a likelihood of a resupply arriving table 100 together with a likelihood of running out table 102. A combination engine 101 receives the data from the likelihood of resupply arriving table 100 and the likelihood of running out table 102 and determines an appropriate time to provide the resupply to the user. The appropriate time to provide the resupply of goods to the user may further be based upon an operator configuration table 104 to modify the resupply of the goods based upon user preferences. An order generation engine 105 may determine an appropriate time to provide a resupply of the goods based upon the table combination engine 101 and the operator configuration table 104. Based upon the order generation engine 105 a resupply of the goods is sent, mailed, or otherwise provided to the user. The tables may be included in a single or multiple tables. The combination engine and the order generation engine may be combined, as desired.

The likelihood of resupply arriving table 100 may represent the shipping and/or order processing times for the particular goods, which may be further based upon particular vendors of the particular goods and the shipping times of the particular goods based upon the geographic source of the goods and the geographic destination of the goods being provided to the user. In some cases, the goods may be of a different characteristic, a different weight, a different size, a different availability, and of a different shipping time. Furthermore, the likelihood of arriving may vary based upon the particular day that such resupply goods are requested and the time to ship such resupply goods to its destination. For example, resupply goods requested on Monday may arrive on Thursday and resupply goods requested on Tuesday may arrive on Wednesday and resupply goods requested on Wednesday may not arrive until the following Tuesday. The system may further use a machine learning technique to further refine the likelihood of resupply arriving table 100 based upon environmental factors, user based factors, supplier specific data, as well as historical order data. In this manner, the likelihood of resupply arriving table 100 provides an indication of the likelihood that a particular resupply of goods will arrive at a particular user.

By way of example, the likelihood of resupply arriving table 100 may take the form of a set of probabilities for a range of future dates. One exemplary representation of this data may be as follows: [0.01,1 days; 0.05 2 days; 0.3, 3 days; 0.8 4 days; 0.95 5 days] with the syntax of [probability 1, timeline 1, probability 2, timeline 2].

The likelihood of running out table 102 may represent the likely time that the particular goods, further based upon the particular characteristics of such goods, will be consumed by the user, as more fully explained below. By way of example, the likelihood of running out table 102 may take the form of a set of probabilities for a range of future dates. One exemplary embodiment of this data may be as follows: [0.1, 1 day; 0.2, 2 days; 0.3, 3 days; 0.5, 4 days; 0.6, 5 days; 0.75, 6 days], with the syntax of [probability 1, timeline 1, probability 2, timeline 2].

The combination engine 101 determines an appropriate time to resupply the goods to the user based upon the likelihood of resupply arriving table 100 with the likelihood of running out table 102. By way of example, the determination of the appropriate time may be a combination of corresponding timelines and probabilities by multiplying corresponding timeline values. For instance, if the likelihood of running out table 102 had for its first two values [0.2, 1 day; 0.3, 2 days] and the likelihood of resupply arriving table 100 had its first two values as [0.01, 1 day; 0.2, 2 days] the combined table from the combination engine 101 may be [0.002, 1 day; 0.06, 2 days].

The operator configuration table 104 may contain a range of different probability levels to further modify when a resupply should be ordered. By way of example, the operator configuration table 104 may include the dates of the week which a resupply should be received, the pattern of usage based upon the day and/or month and/or season of the year, the preference of the user to increasing the likelihood that a resupply arrives early, the preference of the user to increasing the likelihood that a resupply arrives late, and to further modify when a resupply order should be triggered. For example, the operator configuration table 104 may take the form of a set of threshold probabilities for any given date, a set of threshold probabilities for specific dates, and a set of threshold probabilities for the cumulative total for all probabilities of all suitable dates.

The order generation engine 105 determines an appropriate time to trigger an order based upon the operator configuration table 104, and the output of the combination engine 101. The order generation engine 105 therefore determines a time to trigger an order to reduce the likelihood that a user has chronically oversupplied or undersupplied goods, and reduces the amount of time that the user has excess goods in their possession.

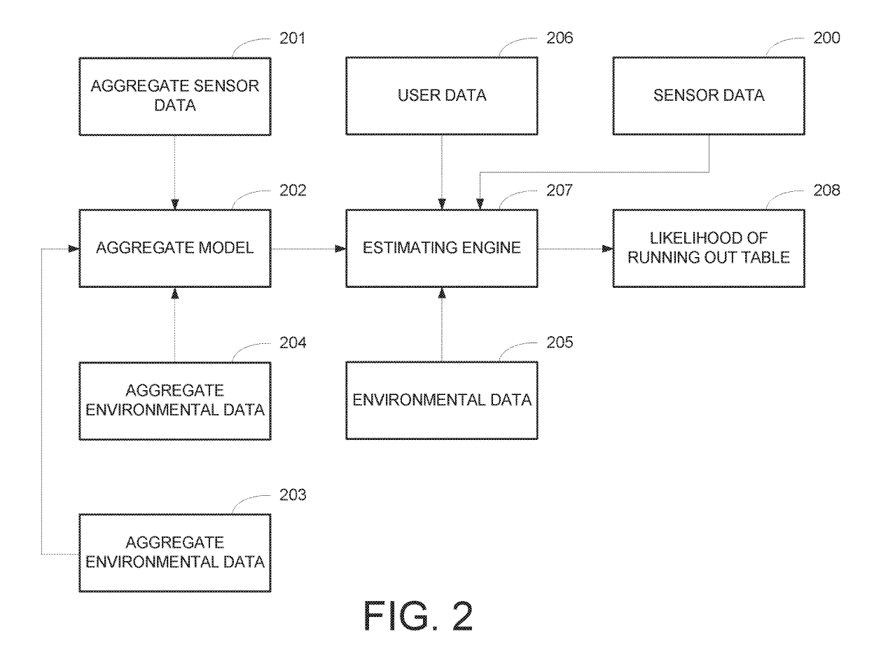

Referring also to FIG. 2, an exemplary embodiment for the generation of the likelihood of running out table 102 is illustrated. The system may determine the likelihood of running out table 102 based upon an aggregation of sensor data 201, an aggregation of user data 203, and an aggregation of environmental data 204. The sensor data 201 may include, for example, a weight of the resupply goods being used by the user over time (e.g., their rate of consumption), and/or the volume of the resupply goods being used by the user over time (e.g., their rate of consumption). In general, the aggregate sensor data 201 is the usage of the entirety or a subset of the sensor data from all sensors in the system. The user data 203 may include, for example, the rate at which the resupply goods are being used by the user over time (e.g., their rate of consumption), the temporal nature of the rate at which the resupply goods are being used by the user over time (e.g., their rate of consumption), the rate at which the resupply goods are being used by one or more other user over time (e.g., their rate of consumption), the temporal nature of the rate at which the resupply goods are being used by one or more other users over time (e.g., their rate of consumption). In general, the aggregate user data 203 is the entirety or a subset of user data in the system. The environmental data 204 may include, for example, the current temperature at the geographic location of the resupply goods of the user, the past temperatures at the geographic location of the resupply goods of the user, the future predicted temperatures at the geographic location of the resupply goods of the user, and the past and/or future humidity at the geographic location of the resupply goods of the user. In general, the aggregate environmental data 204 is the aggregate of recorded environmental data for historical orders and users, which can include weather, holidays and/or any other information that is found useful in predicting consumption. An aggregate model 202 may be determined of the usage characteristics of the resupply goods based upon, for example, the aggregate user data 203, the aggregate sensor data 201, and/or the aggregate environmental data 204.

The aggregate model 202 may be used in any suitable predictive system that can use historical data and build a model that outputs probabilities. By way of example, the system may use a series of regression models where features are generated to represent whether the user ran out for a range of timelines and the aggregated variables are regressed against the generated features. The aggregate model 202 may also take a variety of other forms based upon a machine learning system. The aggregate model 202 may be a model that can accept a set of aggregate sensor data 201, aggregate user data 203, and/or aggregate environmental data 204, and determine a table of probabilities for a set of given timelines. The aggregate model 202 may be further trained based upon aggregate data and user-specific data to determine a particularized model for each particular user.

An estimating engine 207 may further modify the results of the aggregate model 202. The results of the aggregate model 202 may be modified with input of user data 206, user-specific sensor data 200, and/or user specific environmental data 205 to provide data for the likelihood of running out table 208.

As previously described, the system provides an effective technique for determining the resupply for consumable goods based on sensors placed to measure the level or flow of a good, and using the data determined in a predictive manner to determine the likelihood of running out of a good before resupply is likely to arrive. In this manner, an order may be triggered so that it arrives before the supply of goods is exhausted.

As previously described, a sensor may be used to track consumption levels and/or the use of a consumable good. The sensor may communicate with a network using any suitable technique, however, since it is often inconvenient to wire each such sensor into a network the sensor preferably uses a wireless connection to communicate to a network. In one embodiment, the sensor is a weight sensor that senses the weight of a package, such as a bag of coffee, that includes a wireless connection to a network. The sensor, thus provides data either automatically and/or upon request and/or periodically to the network to monitor the consumption of the goods. The device within which the sensor is included is preferably a size consistent with that of the goods so that it may support the consumable goods. Depending on the particular system, there may be multiple sensors for one or more goods. In addition, there may be multiple different sensors for multiple different goods that are sensed.

For example, a weight scale may be used together with a wireless interconnection for providing sensor data to a network. The consumable goods may be placed on the weight scale, such as coffee beans, to sense and provide data regarding the temporal consumption of such goods. The data provided by the sensor preferably includes corresponding timestamps over the Internet to an application programming interface. The data obtained from the weight scale may be stored in a database and used by the predictive system.

For example, the system may include an array of different scales, each of which are customized to the particular goods, to provide a scale that is suitably sized and shaped to the particular goods. In this manner, the particular goods fit onto the scale in a manner that facilitates convenient removal and replacement of the consumable goods onto the scale. By way of example, the scale may be a flat scale with dimensions consistent with the bottom of a coffee bag, so that the coffee bag may be readily placed on the top of the scale. The scale system may not be necessarily flat, for instance, the scale may be suitable for “fridge packs” of cans that may be angled with the front lower than the rear so that the cans can naturally roll forward.

For example, the scale system may be battery powered, with the majority of its time being spent in “sleep mode” except to periodically wake up, read data, send data, and return to sleep mode. In this manner, the battery will have an extended life span before needing to replace the batteries.

For example, the scale system may include a button or other interface accessible to the user to configure the system with wireless connection credentials. The button, or otherwise, when depressed wakes up the scale, turns on a wireless access point which uses a web server to serve up a web form to the user. When the web form is submitted it creates and submits wireless credentials to the user. After pressing the button or otherwise, the scale may stay in a “configuration mode” for a predetermined amount of time before turning to “sleep mode”. If the scale receives the credentials before returning to the sleep mode, it may attempt to connect using the credentials. In the case of the credentials being accepted, the scale may return to sleep, and in the case of the credentials not being accepted, the scale may remain in an access point mode for a predetermined amount of time before returning to the sleep mode.

For example, the sensing systems for the consumable goods are preferably included with integrated sensors therein. In one embodiment, a carafe that holds coffee beans may incorporate the scale with the carafe itself.

In an embodiment of the system, the scale described previously attaches with a clip to the bottom of the packaging, with the scale being removable once the current package is exhausted.

For example, the system may include an API that is deployed which runs a web server which receives data from the sensor systems. The API accepts the data and stores it in a database for use in the system.

For example, the system may graph consumption patterns that are generated from sensor data and display the patterns within a variety of front end systems.

For example, the system users may access an array of goods in a web store. When the user chooses a product, a corresponding sensing device which fits the device's packaging is shipped to them as well as the first order of the good. The user then stores the good in compliance with the device functionality, and before the good runs out the system sends them resupply which the user places on the device as soon as the current good stock is depleted.

For example, the system may permit the user to access a list of products associated with their accounts and sensing devices and change products through a web store. If the user is changing the product associated with a device, they are shown other products that fit with that device. When a user chooses another product, the system will begin ordering the new product when sensor data shows the current product will run out.

For example, the system may permit the user a time window between when they're notified of impending resupply and the triggering of an order. The user receives a message when the system decides to re-order a given product which gives the user the option to cancel the order, remove the product entirely or to switch the product for a different product before the time window completes. One embodiment of the system shows related products to the current product that the user has “synced,” for instance if a user is receiving dark roast coffee currently, the related products would be other types of dark roast.

For example, orders for resupply may be routed to suppliers' existing inventory management and order processing systems. In an alternative embodiment, a system is provided for suppliers which allows for the processing and handling of orders. In such an embodiment, the system can incorporate the predictive systems further up the supply chain, providing suppliers with data on optimal production timelines based on the predictions of their users' consumption patterns.

For example, users may be able to pause their accounts in order to prevent further resupply orders from being generated.

For example, battery powered scale devices may send battery life data along with levels and time data in order for the system to predict when the device is going to run out of battery. When the device is close to running out of battery the system can either message the user to charge the device, send the user a fully charged device, or send the user a replaceable battery depending on the device design.

For example, sensor containing devices may be powered by plugging into the wall instead of batteries.

For example, the sensor data representing the levels and/or use of a good may be used to generate a table of probabilities representing the likelihood of running out of the consumable good for a range of future dates. Many techniques may be used for creating predictive systems for time-series data. One embodiment may include a set of linear regressions run on a computer system, although a variety of machine learning systems may be used. Generally, the system may train a model on aggregated and user specific sensor data as well as other possibly predictive data, this model may take user-specific sensor data, possibly augmented with other predictive data, and output the table of probabilities of running out within given future dates.

For example, a table of probabilities of supply not arriving may be generated for a range of future dates. This table could be generated using a range of techniques from a static table which generally represents typical shipping and fulfillment timelines for a given supplier, to a predictive system taking many types of data as an input including but not limited to distribution endpoints, distribution methods, user location, weather etc.

For example, the table of probabilities for supply not arriving and the table of probabilities for the user running out of the good may be combined to create a table of probabilities for a range of future dates of the user running out of a good before resupply arrives.

For example, the operator or the system may provide a configuration representing a probability of running out when the system should trigger a resupply order. This configuration may include settings for any individual future date, specified future dates, and/or all probabilities combined.

The user may have a one sensor enabled device or the user may have multiple sensor enabled devices. In a multi-equipment set up, when a user selects a product, the system checks in the database whether any of their current pieces of equipment are suitable for the given product. If they are, then the user is asked through a user interface whether they'd like the product to be linked with the existing equipment (if there are multiple pieces of equipment, they are asked which one) or whether they'd like a new piece of equipment sent. Multiple sensors can also be added to a single piece of equipment, and be treated in the system as if each sensor were a unique piece of equipment.

One limitation of the aforementioned system is that the user is not in control of orders, and therefore their expenditure. This limitation may be alleviated by having the orders generated in a “pre-order” state, to be executed at a later date. When an order is generated in the “pre-order” state, the user is notified of the time when it will be triggered. In the “pre-order” state, the order's execution date/time, product, quantity and other details are mutable, and only finalized when the order is triggered.

The user is able to change order details through a user interface up until the order's trigger time. This includes delaying the order by a fixed amount of time or until a specific date/time. When the trigger time passes, the order's product, quantity, and other details become immutable.

The product associated with a given sensor-enabled equipment can be changed through a user interface up until the order's trigger time passes. When the trigger time passes for an order, the system chooses whatever product is associated with the equipment, or next in the product queue (described below).

In order to keep supply chains short, in some implementations the system will offer only products to customers within a given distance or delivery time. In an aspect of the system, a warning message can be disabled to the customer through a user interface. When this is disabled, the customer is provided with product options from a wider geographic area or delivery window.

For example, the system may allow a user to select a single product per sensor-enabled equipment through a user interface, this product is ordered repeatedly until the user changes the product for another one.

For example, in another configuration of the system may associate an ordered list of products with each sensor-enabled equipment. Each time the user adds a product to a sensor-enabled equipment the product would be added to the end of the list. In the initial state, the list would only have the first product added. Each time an order is finalized, the first item of the list is added to the order and removed from the list, unless the list only contains a single product, in which case the single product remains in the list. A message can be sent to the user warning that they have exhausted their list and the same product will be reordered unless the user edits it.

This queue may be editable by a user interface. The user can choose to remove products from the list or reorder the list.

In embodiments with “stock-based” (such as load cell or strain gauge) sensor-enabled equipment, there is the risk of users failing to engage the stock of product with the equipment. When the system receives readings within a given range of zero for an amount of time set by the system operator, during which a re-supply order is not already in transit, the system sends a message to the user prompting them to engage the product with the device. A routine is initiated each time the system receives a reading that is within a given range of zero, set by the system operator. This routine checks for the last non-zero reading and sees if its timestamps is beyond a set amount of time, and that a re-order was not initiated within a different set amount of time.

This alert can also contain a warning message that warns that the system will assume that the associated sensor is out of product within a given amount of time, therefore triggering an order. The system periodically checks data from sensor-enabled equipment to check whether they've been at “zero” for the amount of time specified, triggering reorders.

The message described herein can contain a link to trigger the reorder directly.

For a variety of reasons, data occasionally does not flow from sensor-enabled equipment. This includes dead batteries and connectivity issues. The system periodically loops through active sensor-enabled equipment to check to see if data has been received that's associated with that equipment within a given amount of time set by the system operator, sending messages to users if the time since last reading is longer than the specified time.

In one aspect of the system, battery powered equipment may send battery voltage information that gets translated into battery life estimates, or sends battery life estimates directly to the server. When the battery life estimates get below a certain level, set by the system operator, the system triggers a message to be sent to the customer reminding them to charge their battery.

In an aspect of the system, users can “pause” any sensor-enabled equipment, or their entire account through a user interface.

Setting a sensor-enabled equipment or an account to paused updates the representation of the sensor in the database. Before orders are created, the system checks to see if the sensor-enabled equipment or the user's accounts are paused in the database, not ordering if that's the case.

Users can be messaged that their account is still paused after an amount of time set by the system's user that a given equipment/account is still paused. This is done by recording the time a user sets equipment or their account to paused, and looping through these records.

An alternative embodiment is to prompt users to select an amount of time or given end date for the account to be paused when they are pausing their account.

When a given equipment is paused (or the account that the equipment is synced to is paused) the records from that equipment also record that it was paused at that time, so this data can be used for prediction and other purposes.

For example, the system may use user data to create orders. These orders can be fulfilled by the system operator or sent to third party vendors.

For example, data may be used to optimize product production. This is done by creating demand predictions with confidence intervals for periods that line up with ordering and production schedules. In this aspect of the system, demand predictions and confidence intervals may be created for a given product for a variety of future timelines. These predictions may leverage predictions for customers switching into and out of a given product. These demand predictions could be fed either through a dashboard or application programming interface to the producer of the given product.

For example, where a product supplier has to produce product 3 days before fulfilling orders and order raw materials 3 days before that, the vendor would look at the system's prediction and confidence interval for 3+ shipment time days in the future to inform them on the amount to produce and the prediction/confidence intervals of 10+ shipment time days in the future to inform the ordering of raw materials.

Orders can be sent to vendors or the system operator in a variety of ways. One such method is to integrate with a vendor's existing system for managing orders through an application programming interface, this would send order details into the interface a vendor already uses. Additionally, order status information can be accessed from the vendor's existing system either by polling an application programming interface or by having a server endpoint listening for data.

Another option is a user interface which displays orders and their fulfillment status. The vendor can then use buttons to move orders along various statuses. When vendors move orders along statuses, users may be prompted about the status of their order.

In addition to the graphs of user data described previously, various statistics of consumption can be displayed to users through a user interface. Examples include average daily/weekly/monthly consumption or broken down by day of week. Consumption can also be displayed based on weather. Predictions of customer consumption can also be displayed.

Additionally, when a customer is warned of an impending order, predictions can be included to give context. This can be represented numerically or graphically.

An online store may be provided so customers can choose items to be linked to sensor-enabled equipment. This may be done through a user interface and with visual representations for each product. Visual representations can be filtered or sorted. Products can be displayed only if they're within a given geographical distance or supply chain distance from the consumer. Products can have a button to link them to an equipment directly in their visual representation, or in an additional page with further details.

If the customer has no sensor enabled equipment installed that fit a product chosen through the store, the customer is prompted to choose new equipment. This equipment can be for free use, for sale, for rent/lease, or for a refundable sale upon a first re-order,

If the customer already has sensor-enabled equipment that fits the product being added, they are asked whether they'd like to replace the product that is already synced with the equipment, or get new equipment to handle the product.

One level of service for the currently described system is for each product to represent a single product that is sent repeatedly. Another configuration is a “rotating” product that represents multiple sub-products. In this configuration, when an order is triggered, a subroutine is instantiated which picks from a list of sub-products to be delivered. To choose a sub-product the system checks the user's recent orders and excludes all recent purchases, then chooses either the first product of the ordered list, or randomly. If all the products in a list of sub-products have been ordered by the customer, the system prioritizes for the products that have been ordered the least amount of times, choosing either randomly or based on the list order. In the case where all the products in the sub-product list have been sent to a customer before, an alert can be sent to the customer.

The system may initiate orders based on a computed likelihood of running out of a product based on prediction models. This allows the operator to set the likelihood level above which the system initiates re-orders. Another configuration of the system allows the operator to customize levels for any given customer.

The system may have a limitation that customers have different desires for how “aggressive” the system is in initiating re-supply. Some want the system to send product more often, minimizing the risk of them running out. Others prefer that product is shipped with the lowest likelihood of having extra stock, which inherently has higher risk of running out.

One technique for reducing this aggressiveness limitation is to allow users to select a preferred level of likelihood of running out above which the system orders. This may be done through a user interface and can either take the shape of the user selecting a numerical likelihood directly, or from a range of natural language descriptions that translate to likelihoods by the system.

In order for sensor data to be more useful for predicting consumption, it may reasonably represent consumption flows. Data from “flow” style sensors can be used with minimal processing. The data from “level” based sensor-enabled equipment needs additional processing in order to reasonably represent consumption.

To move from “level” based readings to consumption estimates, each level may be subtracted from the previous one to create a series of differences, multiplying them by -I to get positive numbers.

These differences begin to approximate consumption but may include manipulations to increase their usability. Such manipulations can be done on a server, or on the device. The resulting representations of consumption can be stored or re-generated from raw data each time a new model is built.

When a new product is added to the “level” based sensor, this is represented in the series of differences as a large negative number, and therefore these instances may use additional processing. In this case, the old product amount is accounted for as well as any lost amount in the new product before the reading took place. This can be done by adding the level before the large increase and the expected level based on product information, and subtracting that from the level after the increase. If the result is positive, this is added to the series of differences as an estimate for consumption and the large negative number is removed. Each time a large negative number is found in the series of differences, it may be associated with an order. If there are multiple large negative numbers between two orders, each instance is processed through the process presently described and a scoring system is used to determine which increase should be added to the series, the rest of the increases are discarded.

One limitation that occurs in “level” based systems is when product packaging is disengaged with equipment during recording periods. One way to handle this is to remove all readings within a range of zero (e.g., sufficiently small or below a threshold), determined by the system operator, before the series of differences is calculated. The zero readings are filled in with the last non-zero reading. This causes an underestimation of the final consumption when the product is exhausted. To compensate for this, the final level before a new product is engaged, minus any level added by product packaging, to the series of differences. This can be averaged over the last few readings or added as a single lump difference.

Another limitation with the processing of “level” based systems is when the sensor sends no readings for a period of time. This can happen when a battery dies, connectivity credentials change, the user moves the location of the equipment or many other reasons. To account for this, the missing data can be filled in in a variety of ways. One way is to average the difference of the last reading before the missing data and the first reading afterwards over the amount of periods that the data went missing. Then this average can be applied to fill in the periods.

Early in a given customer's life, models should be retrained frequently, since there's not enough data to be certain about a customer's consumption patterns. As the customer's lifetime continues, models may be trained on less frequent periods. One way of doing this is retraining over repeating, but lengthening intervals. This may be implemented by a function that accepts the customer lifetime for a given product type and returns an interval. If the interval is longer than the time since last model training, the model is retrained.

Another way of doing this is to test the model's performance. This can be done by checking previous predictions, and checking the predictions against the actual data. Errors can be used to create a fit score through a variety of techniques. Models may be retrained when the score doesn't meet a level specified by the system operator.

The server side of this system can be either used to make predictions for the operator, or for third parties. To do this for third parties an application programing interface is used over a server which allows a third parties to send sensor readings, users, products, vendors and other details to an endpoint, and the server returns predictions and/or order triggering.

One limitation with the presently described system is that equipment can be idle with no re-orders. To reduce this, an aspect of the system tabulates inactivity to be used to inform either customer fees or messages. The inactivity can be tabulated in a rolling time period, or periodically. This is accomplished by looping through equipment representations and checking for the last time an order is placed.

For example, stock based sensors may incidentally pick up the presence of additional implements. For example, a lid on top of a canister with a weight sensor, or a canister on top of a scale. The sensor-enabled equipment may be able to determine the presence of the additional implements in order to adjust the level when processing the data.

To do this, additional sensors are added to sense the presence of the implement, and these values are included with the sensor data as additional values. The database representations for each type of equipment contain the values needed to adjust for the presence or non-presence of various implements.

Additionally, an optional implement can be “hardcoded” into an equipment's representation. This may be done by modifying the calibration directly based on the system operator's knowledge of the presence of an additional implement. This knowledge may come directly through customer communication, or automatically such as when a container for a specific device is sold.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I claim:

1. A system for estimating a time to reorder consumable goods comprising:
(a) a likelihood of resupply arriving table indicating a likely time for arrival of goods being shipped to a consumer;
(b) a likelihood of running out table indicating a likely time for goods running out by said consumer based upon a sensor sensing said consumable goods;
(c) a consumer configuration table including configuration settings by said consumer;
(d) an order generation engine that determines a time to said reorder said consumable goods based upon said likelihood of resupply arriving table, said likelihood of running out table, and said consumer configuration table.

2. The system of claim 1 further comprising a combination engine that determines a first likelihood based upon said likelihood of resupplying arriving table and said likelihood of running out table.

3. The system of claim 2 wherein said order generation engine determines said time to said reorder said consumable goods based upon said first likelihood and said consumer configuration table.

4. The system of claim 1 wherein said likelihood of resupply arriving table is further based upon at least one of a shipping and an order processing time for said consumable goods.

5. The system of claim 4 wherein said likelihood of resupply arriving table is further based upon a vendor of said consumable goods.

6. The system of claim 5 wherein said likelihood of resupply arriving table is further based upon a geographic source of said consumable goods and a geographic destination of said consumable goods.

7. The system of claim 1 wherein said consumer configuration table is further based upon a day of week preference.

8. The system of claim 1 wherein said consumer configuration table is further based upon a month preference.

9. The system of claim 1 wherein said consumer configuration table is further based upon a season preference.

10. The system of claim 1 wherein said consumer configuration table is further based upon a preference to whether said consumable good is early or late.

11. The system of claim 1 wherein said likelihood of running out table is further based upon aggregate user data.

12. The system of claim 1 wherein said likelihood of running out table is further based upon aggregate sensor data.

13. The system of claim 1 wherein said likelihood of running out table is further based upon aggregate environmental data.

14. The system of claim 1 wherein said likelihood of running out table is further based upon an aggregate model based upon aggregate user data, aggregate sensor data, and aggregate environmental data.

15. The system of claim 14 wherein said likelihood of running out table is further based upon an estimating engine based upon user data, sensor data, and environmental data.

16. The system of claim 1 wherein said estimating engine is further based upon said aggregate model.

17. The system of claim 1 wherein said consumable goods are maintained within a carafe that includes said sensor integrated therein.

18. The system of claim 1 wherein said sensor is provided together with said consumable goods and said order generation engine automatically provides said reorder of said consumable goods.

19. The system of claim 1 wherein said order generation engine provides said reorder of other consumable goods different than said consumable goods.

20. The system of claim 1 wherein said order generation engine is configurable to different said consumable goods for said sensor.
